(19) United States
(12) Patent Application Publication
(10) Pub. No.: US 2010/0332837 A1
(43) Pub. Date: Dec. 30, 2010

(54) WEB APPLICATION SECURITY FILTERING

(75) Inventor: CYRILL OSTERWALDER, DACHSEN (CH)

Correspondence Address: PATENTRY, P.O. BOX 151616, SAN RAFAEL, CA, 94915-1616, US

(73) Assignee: PHION AG, INNSBRUCK (AT)

(21) Appl. No.: 12/703,148

(22) Filed: Feb. 9, 2010

(30) Foreign Application Priority Data
Jun. 29, 2009 (CH) PCT/CH2009/00024

(51) Int. Cl. G06F 21/20; G06F 21/24; H04L 9/32; G06F 15/16

(52) U.S. Cl. 713/172; 726/30; 726/11; 709/203

(57) ABSTRACT

User inputs and/or Uniform Resource Identifier (URI), historically and popularly referred to as Universal Resource Locator (URL), requests in a content description language are passed through a security service (Web application firewall or a reverse Web proxy server) that is placed in front of Web application servers in order to protect the servers from hacking attempts. For validating Webform user inputs and/or URI requests and parameters the content description language is enriched by the security service with additional security tokens that are dynamically created based on the content being transferred. The user receives the information and returns input with the security tokens. The security service can then verify all provided user input data against the constraints described in the corresponding security token. As a result, the method may block the HTTP request or create log messages or notification events in reaction to violations of the user input data compared to the constraints in the security token.

The present patent application claims priority of PCT/CH2009/000224 filed 29 Jun. 2009.

### TECHNICAL FIELD

The present invention relates to the field of Web application security filtering. More particularly this invention relates to filtering malicious user input data provided in Web application forms or Web application requests (URLs and parameters).

### BACKGROUND ART

Protocols are conventions or standards that control or enable the connection, communication and data transfer between two computer endpoints, wherein the word computer comprises all devices being able to receive and send digital code. These computer endpoints are conveniently referred to using uniform resource identifiers (URI) in the form of a compact string of characters. A domain name system (DNS) translates a portion of the URI to an Internet Protocol (IP) address. The URI can be used to specify a certain protocol and represent a resource available on the Internet. Non-limiting exemplary protocols include but are not limited to file transfer protocol (FTP), hypertext transfer protocol (HTTP), secure hypertext transfer protocol (HTTPS) and User Datagram Protocol (UDP). Web applications are based on connection, communication and data transfer between such computer endpoints.

On the server side, application servers and other dynamic servers and other dynamic content servers such as Web content management systems provide content through a wide variety of techniques and technologies typified by the scripting approach. Web browsers can be based on different languages, for example on HTML, Java, XML and XSLT. Widespread are Web applications with at least one computer endpoint in the form of a Web application server and at least one client computer endpoint with a Web browser.

Web applications with interactions of Web browsers and Web servers can use content description languages, for example Hyper TextMarkupLanguage (HTML), to display web pages and to make requests. On the client side, the Web application access is typically initiated by using a Web browser (non-limiting e.g. Mozilla, Firefox, Internet Explorer, Opera). A Web browser sends an HyperTextTransferProtocol (HTTP) request to a Web server in order to receive the HTTP response to the request. The response contains the content description language HTML which controls the Web browser to display content, some of which may be retrieved using further URIs and in some cases to interact with the Web application, for example by displaying Web forms, Weblinks or other Web application content.

U.S. Pat. No. 6,345,300 B1 discloses a method for obtaining a user-controlled parameter from a client device arranged behind a network proxy. This method includes the step of content servers receiving through a network proxy a request originated by the client device transmitting a responsive request to the client device, wherein the responsive request includes a query mechanism to elicit a user-controlled parameter from the client device, and receiving the user-controlled parameter from the client device. This solution does not prevent the content servers from hacker attacks.

Available as prior art are methods known as reverse proxy servers that intercept the HTTP requests coming from the client browser before it reaches the Web application server. The reverse proxy server may be used to check the request for validity and decide to which Web application server the request should be sent. If the communication between the client browser and the Web application server is encrypted using the SSL (Secure Socket Layer) protocol; the reverse proxy terminates the SSL connection layer in order to be able to inspect the HTTP protocol inside.

U.S. Pat. No. 6,041,355 describes a method of controlling the transfer of data between a first and a second computer network comprising parsing content description language received from the first computer network by the second computer network to determine current tag information within the content description language. A completion decision is made based upon the current tag information. The completion decision may include full data transfer between the two networks, partial data transfer between the two networks, deferred data transfer at a later time, or a cached data transfer. Restrictions based upon a user's age, a user's access rights, cost, system resources, and time of day may also be employed to limit the transfer of data based upon the current tag information. The content description language is HTML and the method may be practiced by an application level proxy that is part of a firewall system protecting the second computer network from the first. The described method allows restrictions of the data transfer but does not protect Web application servers against active hacking attempts.

There are Web application firewalls or reverse proxy servers which are parsing the content description language HTML in order to store information about the content on the Web application firewall or reverse proxy server as a dynamic configuration policy which can be used for security reasons. The stored security information is variable and therefore the security checks to the same content description language information may be different.

These approaches are based on the parsing of the content description but due to variable stored security information don't protect Web application servers all the time in the same way against active hacking attempts. A further disadvantage is the need of storing, and updating information about the content on the Web application firewall or reverse proxy server.

There are static solutions, where an administrator has to set up security information on the Web application firewall or reverse proxy server. The disadvantage of such a solution is the static nature of the security information and the need for an administrator setting up and maintaining the security information.

US 2003/0154296 A1 discloses a keyword restriction facility established between a Web browser and the Internet. Connected to the Internet is a Web server which provides various services. The keyword restriction facility includes a restricted word database and blocks request messages comprising a restricted word. The maintenance of the database is time consuming and does not prevent the Webserver from experiencing hacker attacks.

When client Web browsers (non-limiting e.g. Firefox, Internet Explorer, Opera) access a Web application server they receive HTML content which describes what the browser should display and what kind of requests and user inputs are expected by the Web application. On the client side, however, there is no secure environment to ensure that these constraints are complied with. A malicious user may be able to control his browser to bypass such constraints and transmit inputs which attack the Web application.

### SUMMARY OF THE INVENTION

User Input elements and/or URIs in a content description language (for example HTML) pass through a security service embodied as software adapting a processor apparatus. The security service is preferably installed on at least one Web application firewall or on at least one reverse Web proxy server that is placed in front of Web application servers in order to protect the servers from hacking attempts. For validating URIs, user inputs or parameters of requests the content description language of the request is enriched by the security service with at least one additional security token that is dynamically created and based on the content being transferred. The user who receives the enriched information must return it faithfully with the user data input to even be considered for access. If the enriched information is tampered with or removed, the transaction is terminated and the user data input is discarded. The security service can then verify all provided user input data against the constraints described in the security token. Note that the constraints are encoded within the security token and that an apparatus which generates a token can be physically and logically different from an apparatus which reads, validates, and enforces the token. This solution guarantees that the information used for verifying the user input fits to the request to which the user input was sent.
Because the invention provides that at least one security token is added by the security service,

is transmitted to the user and by the user back to the security service and

is used by the security service for the security check,

there can be no mismatch or inconsistent checking. An other advantage of the present invention is that there is no need for the security service to store and update security information for each form or for each user.

The security service can be installed or implemented on the Web application firewall or on the reverse Web proxy server. The security service could also be installed on a Web application server, but such a solution is not able to block hacking attempts before reaching the server. The security service can be installed or implemented on a dynamic load balancer apparatus so that in the event of an attack, more filters can be launched to verify tokens outboard of the application server and the load on the server will not be affected by invalid data inputs.

If the new and inventive Web application security filtering is made by a security service at a Web application firewall or a reverse Web proxy server or dynamic load balancer, then the blocking is made at the Web application firewall or at the reverse Web proxy server or at the dynamic load balancer and not at the Web application server. The Web application server will not suffer under attacks with a huge number of incorrect responses to requests since these incorrect responses will be blocked and will not reach the Web application server.

The invention can be adjusted to different situations. For example, it would be possible that a request from a Web Application server is passing through a security service at a first Web application firewall or a first reverse Web proxy server and the input to the request is passing through a security service at a second Web application firewall or a second reverse Web proxy server. The information needed by the security service for filtering is in the security token and therefore the security service can be installed at a plurality of different devices preferably at different Web application firewalls or different reverse Web proxy servers. While the security service parsing the input information need only be able to decrypt and verify the security token encrypted and digitally signed by the security service at an other device, the different devices with the security service don't need to receive and maintain constraint information in storage since the constraint information is embedded within the HTML content. The service can be rapidly scaled to handle attacks.

The described method parses the content description language when being transferred from the Web application server to the client. Based on HTML tags and the corresponding attributes of these tags, the method creates encrypted security tokens for example with digital signatures that are embedded into the Web form of the content description language in such a way that the client browser will return the security token to the server when submitting the Web form with the provided user input data. The security tokens can be perfectly protected against hackers and are added to the content description language sent to and received from the user.

In an embodiment the expected value types and allowed value ranges are included in the security token and can therefore be deleted from the content description language sent to the second computer endpoint. In the case of encrypted security tokens possible hackers cannot access information on data validation checking.

As a result, the method can block the HTTP request or create log messages or notification events in reaction to violations of the constraints in the security token by submitted user input data. This security filtering is efficient and simple, can be distributed many more places than the number of application servers, and utilizes servers less powerful and less sensitive than the application server.

With encryption, hash functions and digital signatures the security tokens themselves can be protected from attacks or misuse.

The method for Web application security filtering is applied to Web applications which transfer a content description language between two computer endpoints through a apparatus providing a security service. The method comprises the steps of
a) receiving from the first computer endpoint content description language comprising at least one request for input data and at least one constraint to the expected input data,
b) enriching the content description language sent by the first computer endpoint with at least one security token that is based on the at least one request for input data and comprises at least one constraint to the expected input data,
c) sending to the second computer endpoint content description language enriched with the at least one security token,
d) receiving from the second computer endpoint input data together with the at least one security token,
e) parsing input data and the at least one security token sent by the second computer endpoint,
f) verifying the input data against the at least one constraint included in the security token and
g) blocking the transfer of input data which does not conform to the at least one constraint.

In a preferred embodiment, the at least one first computer endpoint comprises at least one Web application server, the at least one second computer endpoint comprises a client computer with a Web browser and the security service is installed on a Web application firewall or on a reverse Web proxy server that is placed in front of the at least one Web application server in order to protect the at least one server from hacking attempts by a malicious client Web browser.

In a preferred embodiment the transferred content description language comprises HTML content.

In an embodiment, parsing the content description language coming from the at least one first computer endpoint, comprises

extracting attribute information that describes URI's, parameter names, expected value types and allowed value ranges and

creating at least one security token that is based on the extracted attribute information.

In an embodiment, enriching the content description language comprises encrypting and in a further embodiment digitally signing the security token. After receiving input data and the at least one security token sent by the second computer endpoint, the security service decrypts and preferably verifies the security token. The step of verifying the security token is a control step which guarantees that the security token was created by the security service. This prevents hackers from adding counterfeit security tokens which could be accepted by the security service.

The inventive method is tangibly embodied in a computer program comprising program code encoded on computer readable media means for performing all the steps made by the security service. This program adapts a computer or a Web application firewall or a reverse Web proxy server.

Instead of a computer performing the method steps by a computer program the method steps can be performed by a security service apparatus for Web application security filterings, said apparatus comprising

a) a circuit to receive description language transferred between at least a first and a second computer endpoint through the security service apparatus,

b) a circuit to enrich the content description language sent by the first computer endpoint with at least one security token that is based on at least one request for input data and comprises at least one constraint to the expected input data,

c) a circuit to send to the second computer endpoint content description language enriched with the at least one security token,

d) a circuit to receive from the second computer endpoint input data together with the at least one security token,

e) a circuit to parse input data and the at least one security token sent by the second computer endpoint,

f) a circuit to verify the input data against the at least one constraint determined by the security token, and

g) a circuit to block or transfer the input data according to its conformity to the at least one constraint.

### BRIEF DESCRIPTION OF THE FIGURES

FIG. 1 is a schematic block-diagram of a first part of the Web application security filtering with the Web Application Server sending information to a client,

FIG. 2 is a schematic block-diagram of a second part of the Web application security filtering with the client sending information to the Web Application Server,

FIG. 3 is a schematic block-diagram with the Web Application Server sending specific information to a client and

FIG. 4 is a schematic block-diagram with the client sending back specific information to the Web Application Server,

FIG. 5 is an illustration of a system in which a first portion of the present invention is coupled to a web application server and coupled through a network to a client,

FIG. 6 is an illustration of a system in which a second portion of the present invention is coupled to a web application server and coupled through a network to a client,

FIG. 7 is a flow chart of steps of a first process for generating a security token comprising constraints on user inputs, and

FIG. 8 is a flow chart of steps of a second process for validating a security token comprising constraints on user inputs and checking the constraints on the data.

### DETAILED DESCRIPTION OF PREFERRED EMBODIMENTS

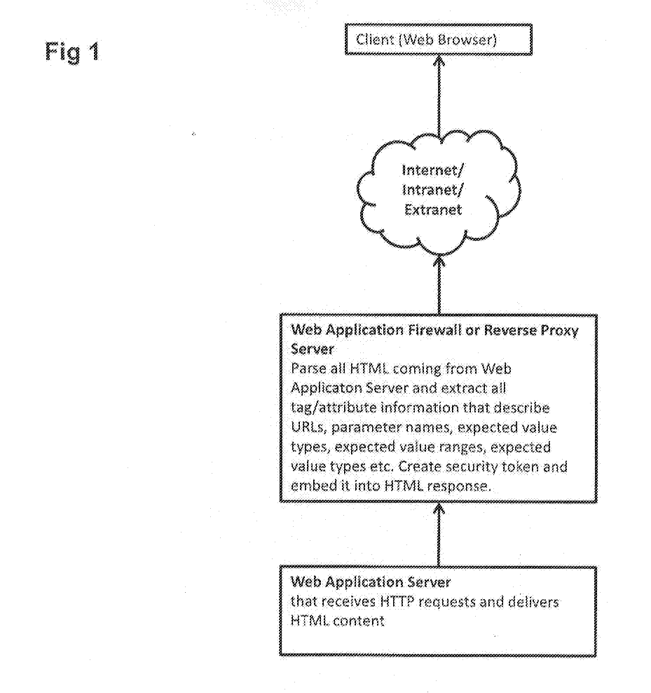

FIG. 1 shows a first part of an embodiment of the Web application security filtering method, whereby HTML content provided by a Web application server is parsed by security service of a Web application firewall or a reverse Web proxy server. HTML request content and tag or attribute information that is relevant to describe valid URIs, parameters, parameter value types, parameter value ranges etc is extracted.

Based on the extracted information, a security token is embedded by the security service of the Web application firewall or the reverse Web proxy server into the HTML code. The security token contains all necessary information to check against the URI or parameter description later and is preferably encrypted and digitally signed. The Web application firewall or reverse Web proxy server does not need to store special information regarding the HTML data or constraints on client inputs.

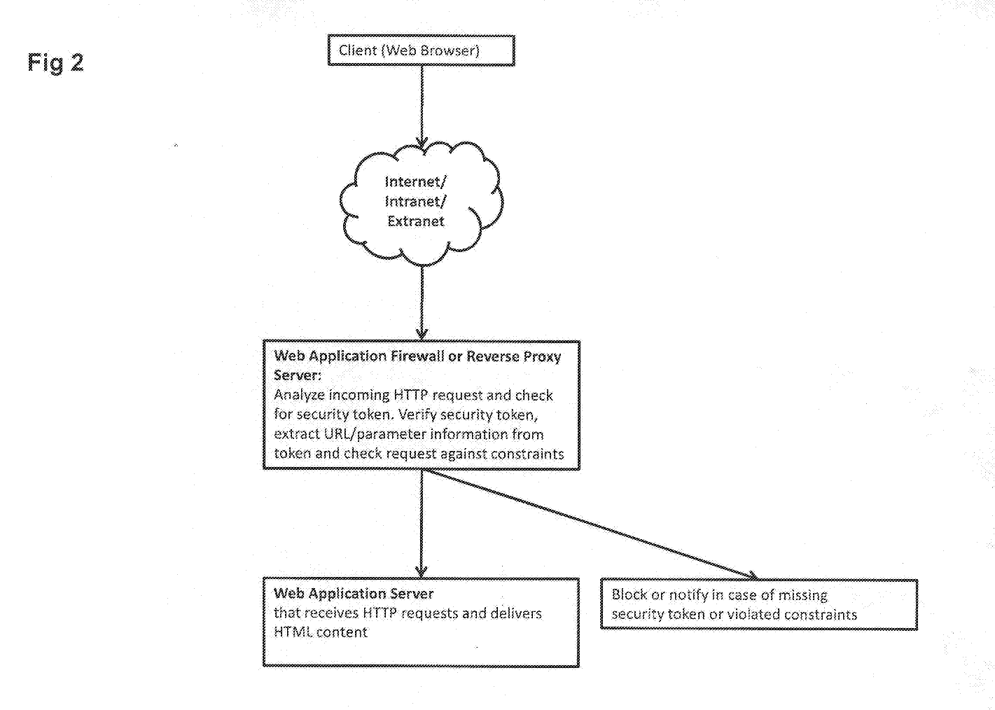

FIG. 2 shows a second part of an embodiment of the Web application security filtering method, which includes the first part of the method shown in FIG. 1. The client Web browser having received HTML content with a security token created in the first part of the method sends the security token together with requested information for which the security token was created—back to the Web application firewall or the reverse Web proxy server. The input and the security token sent by the browser is parsed by the Web application firewall or the reverse Web proxy server. It decrypts and verifies the security token and extracts the input validation constraints that have been encrypted into the token (non-limiting e.g. valid URIs, parameter names, parameter value types, parameter value ranges) It checks the request and its parameters against the constraints of the security token and as a result, may react accordingly if constraints are violated. A similar reaction will be caused in case of a missing or an invalid security token. The reaction comprises blocking the request and/or notifying the administrator of the Web Application servers.

With the new and inventive Web application security filtering the blocking is made at the Web application firewall or the reverse Web proxy server and not at the Web application server. The Web application server will not suffer under attacks with huge numbers of incorrect responses to request since these incorrect responses will not reach the Web application server.

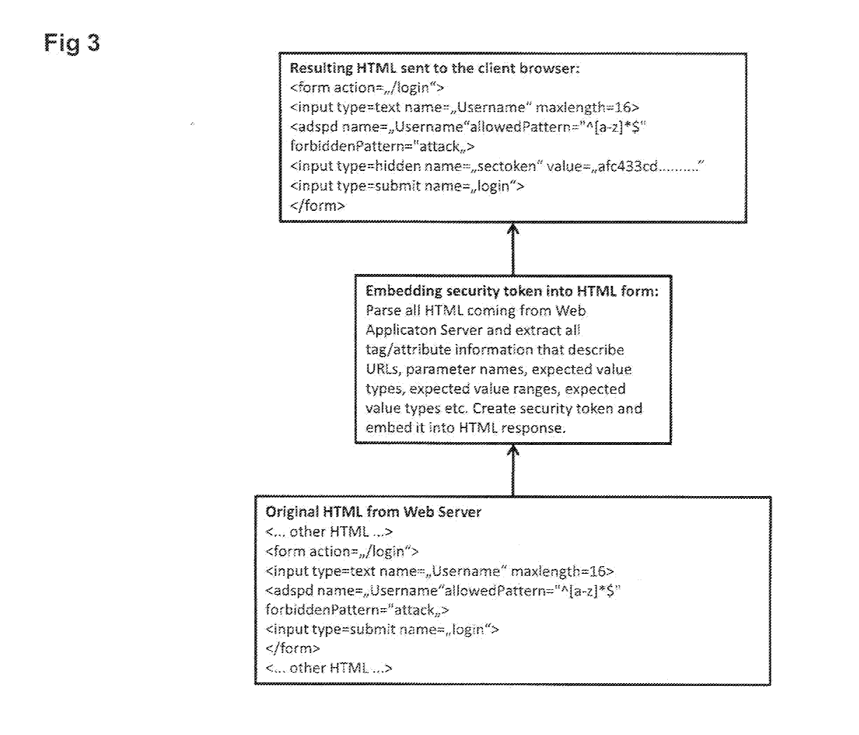

FIG. 3 shows a specific example of the first part of the method shown in FIG. 1 wherein the HTML content being provided by the Web application server comprises login information. The login request include standard content

<form action=“/login” >
<input type=text name=“Username” maxlength=16>
<input type=submit name=“login”>
</form>
and content information in respect of the security service named “ adspd”
<adspd name=“Username”allowedPattern=“\hat{ }|a-z|*$”forbiddenPatern>=
“attack”

The Web application firewall or the reverse Web proxy server is adapted to parse HTML content in order to find information which will be used by the security service” adspd. This information is extracted and includes constraints relevant to valid URIs, parameters, parameter value types, parameter value ranges etc. Based on the extracted information, a security token is embedded by the security service of the Web application firewall or the reverse Web proxy server into the HTML code. The security token contains all necessary information to check against the URI/parameter description. The Web application firewall or reverse proxy server device does not need to store special information regarding the HTML data. The HTML code including the security token is sent to the client.

In an embodiment, when requirements are high with respect to the authenticity of the security token or its creation by a specified security service or by a specified device (Web application firewall or reverse Web proxy server), then a private code is assigned to the specified service or device. Additionally the specified service or device also has a public code. The security service or the processor of the specific device can determine a hash value from the security token, encode it with a private code, and thus generate a digital signature. The security token and the digital signature, together with the encoded information of the security token, can now be sent along with the combined HTML content. The security token is secure against fraud. Checking the unchanged state of the security token can be done by verifying the digital signature and/or controlling the authentic hash value of the security token by using the public code. If the hash value of the security token is identical with the authentic hash value of the security token, then the security token has not been altered.

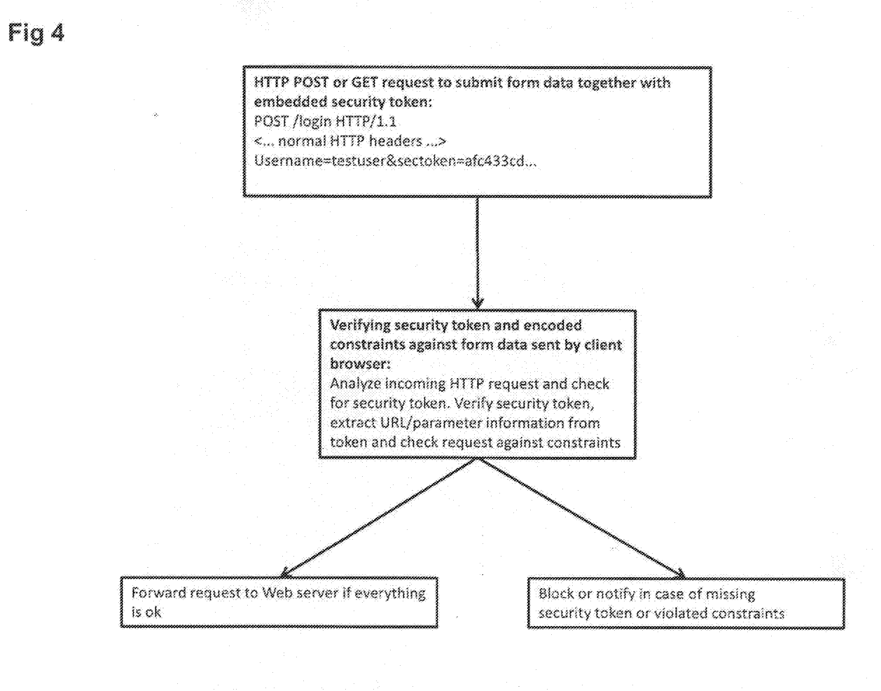

FIG. 4 shows a specific example of second part of the method shown in FIG. 2, wherein a client Web browser respectively the user at this browser, reacts by sending login information or any kind of parameters for which this behavior was configured or activated. The sent information includes the previously embedded security token. In the first part (FIG. 3) of the method the security token was embedded so that the browser will send it with requested information. The information is sent preferably in encrypted form from the browser to the security service of the Web application firewall or of the reverse Web proxy server, where it is checked for the security token. The security service will decrypt encrypted information, which was sent by the browser.

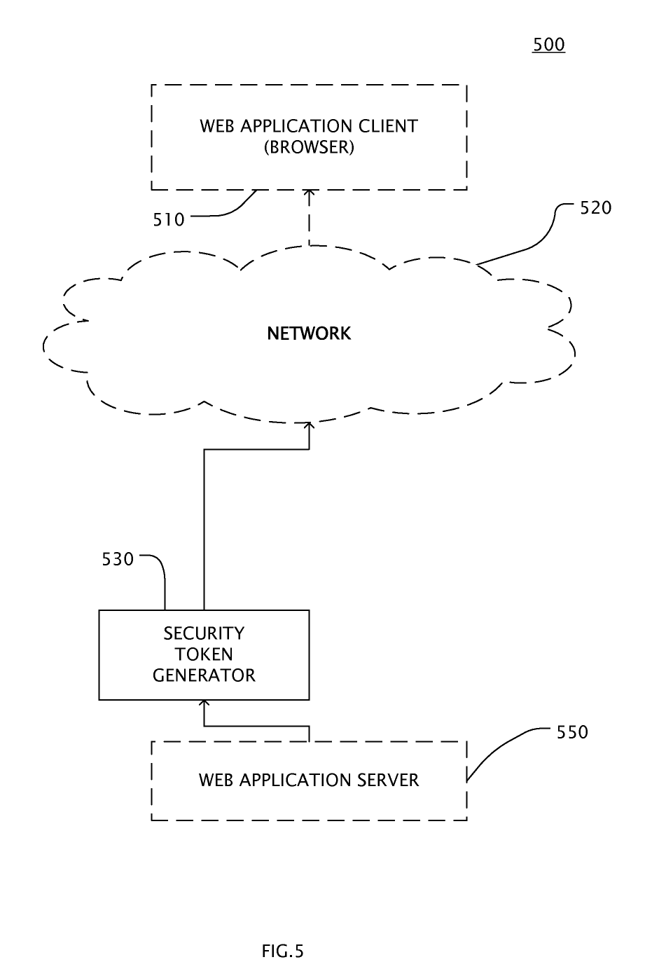

Referring now to FIG. 5, a system 500 comprises a security token generator 530 coupled to a conventional web application server 550, and further coupled through a conventional network 520 to a conventional web application client 510. Responsive to an HTTP request from the client 510, the web application server delivers HTML content via a web application firewall or reverse proxy server which comprises the security token generator 530. The security token generator parses all HTML coming from the web application server 550 and extracts all tag/attribute information that constrains data input fields. Exemplary non-limiting constraints include URI, parameter names, expected value types, expected value ranges, allowed character sets, and length. A security token is generated and embedded into the HTML which is forwarded through the network 520 to the web application client 510. In an embodiment the token is encrypted. In an embodiment the token is digitally signed.

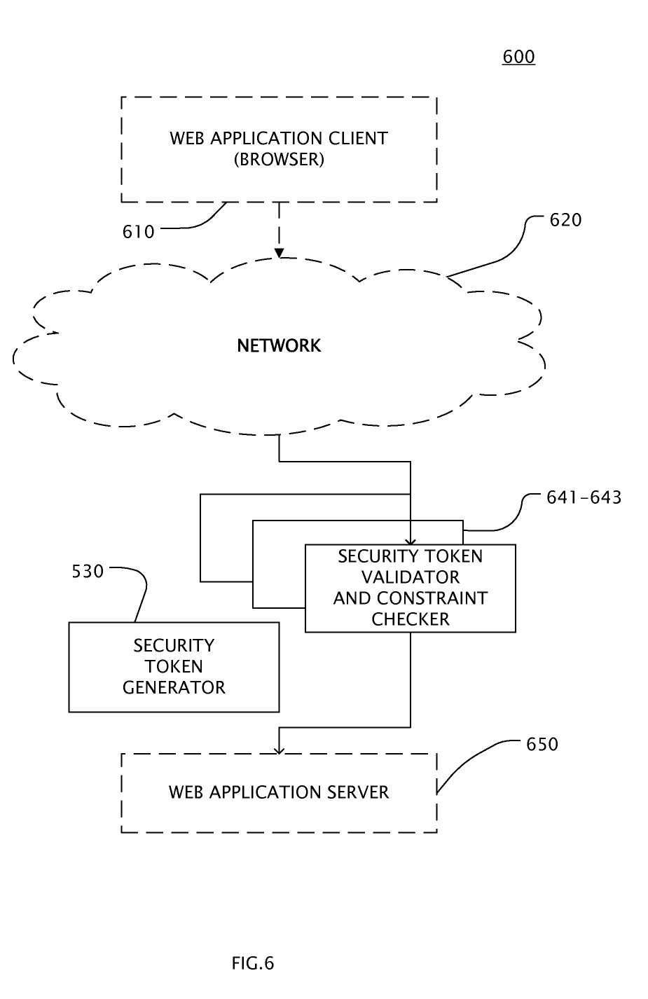

Referring now to FIG. 6, at least one web application firewall or reverse proxy server comprising a security token validator and constraint checker 641-643 is coupled to a web application server 650 and further coupled through a network 620 to a web application client 610 which has submitted data. In an embodiment the data is in a query string. In an embodiment the data is in a form field. In an embodiment the security token validator and constraint checker analyzes the incoming HTTP request and checks for incoming data and at least one security token. In an embodiment it verifies the security token by checking a digital signature. In an embodiment it decrypts the security token. In an embodiment, it extracts URI or parameter information from the token and checks the embedded constraints on the form fields or query strings. In an embodiment there are a plurality of apparatuses configured as security token validator and constraint checker which allows dynamic response to an attack. In an embodiment the security token generator is separately embodied from the validator checker to balance workload. In an embodiment which is suboptimal, the security token validator and constraint checker can share resources with the web application server.

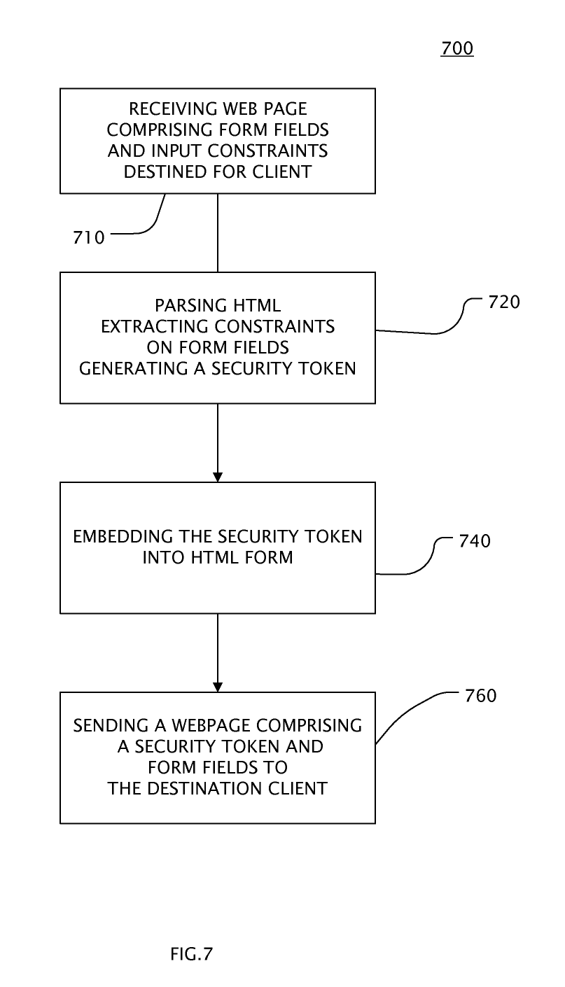

Referring now to FIG. 7, a flowchart illustrates the process 700 for generating and embedding security tokens into webpages containing form fields. Original HTML is received from a web application server 710. The HTML is parsed to extract all tag/attribute information that describes desirable URIs, parameter names, expected value types, expected value ranges, which form constraints on user input. A security token is generated 720 and embedded 740 into the html form. The resulting modified webpage containing the security token is transmitted to the destination client who earlier requested the form 760. While a well behaved destination client may also check the constraints and provide feedback to a user but a malicious client or user may ignore the constraints and attempt to transmit escape characters or overrun a buffer to subvert the web application.

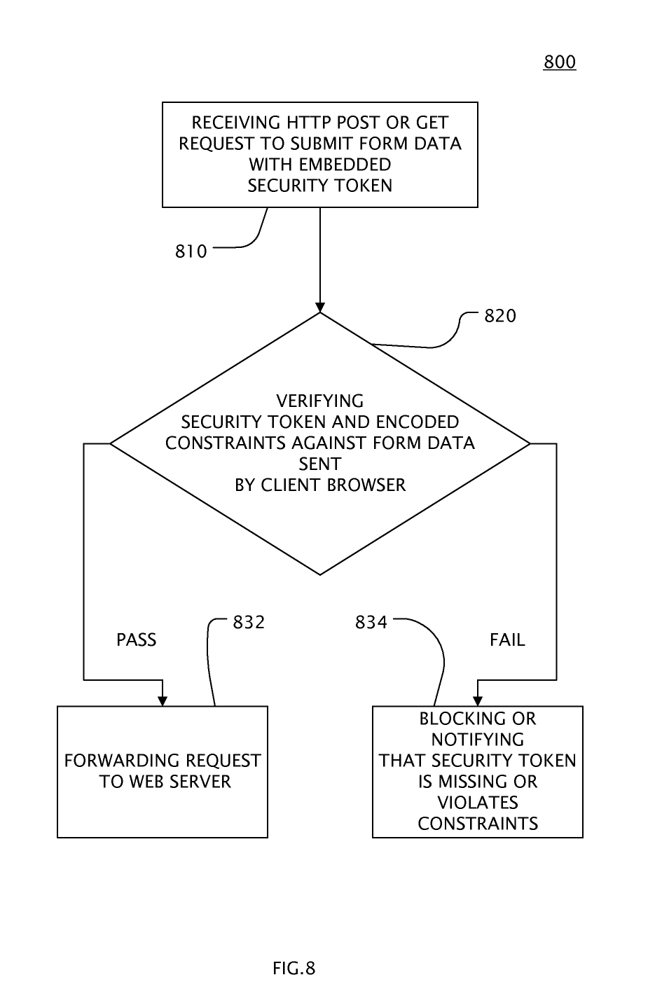

Referring now to FIG. 8, a flowchart 800 illustrates the steps of receiving, verifying, and disposing of a form with an embedded security token. The method comprises receiving an HTTP POST or GET request to submit form data together with an embedded security token. In an embodiment the token is encrypted or digitally signed or both. If the token is invalid the transaction fails, if there is no token but there is data in the form fields, the transaction fails, if the data does not comply with the constraints within the token, the transaction fails 820. Only if the data in the form is compliant with the constraints embedded in the security token does the HTTP request get forwarded to the application web server 832. In an embodiment an administrator or log can be notified about the failures 834.

In an embodiment, there might be a plurality of checks to ensure that the received information comes from a client responding to HTML content sent by a Web server. The security service decrypts and verifies the security token and extracts the input validation constraints that have been encrypted into the token (e.g. valid URIs, parameter names, parameter value types, parameter value ranges, etc). It checks the request and its parameters against the constraints of the security token and as a result, may react accordingly if constraints are violated for example by blocking the request and/or notifying an administrator. If the constraints are not violated, then the request is forwarded to the Web server.

### CONCLUSION

The present invention is distinguished from conventional systems by divorcing the data validation from the application to protect from malicious data entry rather than simple incompetance. The present invention is distinguished from conventional filtering by transmitting the constraints via the client and not storing the constraints on the filter, firewall, or proxy. The present invention is distinguished by dynamically scaling to handle an attack while protecting the web application server from a flood of counterfeit requests. The present invention is distinguished by being a distributed service which can be provided at a distance from the web application server and which can protect a plurality of unrelated web application servers. The present invention is distinguished by in the event of an overflow or successful penetration, the exploit occurs at the firewall and not at the application server.

It is known to those skilled in the art of web application filtering, that a processor coupled to computer readable media provides means according to the claims.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Further, none of these references, regardless of how characterized above, is admitted as prior to the invention of the subject matter claimed herein.

What is claimed is:

1. A method for operating a Web applications security filtering system, the method comprising
a) receiving from a first computer endpoint content description language comprising at least one request for input data and at least one constrain to the expected input data,
b) enriching the content description language sent by the first computer endpoint with at least one security token that is based on the at least one request for input data and comprises at least one constraint to the expected input data,
c) sending to a second computer endpoint content description language enriched with the at least one security token,
d) receiving from the second computer endpoint input data together with the at least one security token,
e) parsing input data and the at least one security token sent by the second computer endpoint,
f) verifying the input data against the at least one constraint determined in the security token, and
g) blocking the transfer of input data which does not conform to the at least one constraint.

2. The method according to claim 1 wherein the system comprises
at least one first computer endpoint comprising at least one Web application serverrver,
at least one second computer endpoint comprising a client computer with a Web browser, and
a security service installed on a Web application firewall or on a reverse Web proxy server that is placed in front of the at least one Web application server in order to protect the at least one server from hacking attempts by client Web browsers.

3. The method according to claim 1 wherein the transferred content description language comprises hypertext markup language content.

4. The method according to claim 3 wherein parsing content description language comprises
extracting attribute information and
creating at least one security token that is based on the extracted attribute information.

5. The method according to claim 4 wherein attribute information comprises name parameters.

6. The method according to claim 4 wherein attribute information comprises universal resource identifiers.

7. The method according to claim 4 wherein attribute information comprises expected data values.

8. The method according to claim 4 wherein attribute information comprises expected value ranges.

9. The method according to claim 4 wherein attribute information comprises expected value types.

10. The method according to claim 4, wherein enriching content
description language with the security token, further comprises
encrypting and digitally signing the security token and after receiving input data and the at least one security token sent by the second computer end point, the security service
decrypting and verifying the security token.

11. A computer program comprising program code means for performing all the steps of the method of claim 10 by adapting a computer.

12. A computer program comprising program code means for performing all the steps of the method of claim 10 by adapting a Web application firewall.

13. A computer program comprising program code means for performing all the steps of the method of claim 10 by adapting a reverse Web proxy server.

14. A computer program comprising program code means for performing all the steps of the method of claim 10 by adapting a load balancing appliance.

15. A security service apparatus for Web application security filtering, the apparatus comprising:
a) means for receiving content description language transferred between at least a first and a second computer endpoint through the security service apparatus,
b) means for enriching the content description language sent by the first computer endpoint with at least one security token that is based on at least one request for input data and at least one constraint to the expected input data,
c) means for sending to the second computer endpoint content description language enriched with the at least one security token,
d) means for receiving from the second computer endpoint input data together with the at least one security token,
e) means for parsing input data and the at least one security token sent by the second computer endpoint,
f) means for verifying the input data against the at least one constraint in the security token, and
g) means for blocking the transfer of input data which does not conform to the at least one constraint.
